(19) United States
(12) Patent Application Publication
(10) Pub. No.: US 2016/0162957 A1
(43) Pub. Date: Jun. 9, 2016

(54) VEHICLE POSITION BASED FUELING STATION REPUTATION SYSTEM

(71) Applicant: Continental Automotive Systems, Inc., Auburn Hills, MI (US)

(72) Inventor: Ivan Jauregui Mercado, Zapopan (MX)

(21) Appl. No.: 14/563,470

(22) Filed: Dec. 8, 2014

(51) Int. Cl. G06Q 30/02; G01S 19/51; G06Q 50/00

(52) U.S. Cl. CPC G06Q 30/0282; G06Q 50/01; G01S 19/51

(57) ABSTRACT

A method provides a rating of a fueling station to a user by determining, using an apparatus, whether a vehicle is located at a fueling station. When the vehicle is located at a particular fueling station, a rating of the particular fueling station is communicated to a user of the vehicle.

### FIELD

The invention relates to providing fueling station information to a user of a vehicle and, more particularly, to a system that provides the user with a rating or reputation of a fueling station where the user's vehicle located and that enables the user to rate the fueling station.

### BACKGROUND

Based on global positioning systems (GPS) in mobile devices or in a vehicle, there are many applications that provide a user of a vehicle the ability to find the nearest fueling station for refueling and an indication of the prices per gallon for each of the various blends of fueling at that fueling station. Most fueling station customers take it for granted that if fueling at the fueling station is $3.00/gallon and they paid $30 for fueling, that they received 10 gallons of fueling. This may not be true if the fueling station is not reputable or if the fuel pump is not calibrated properly. Also, a non-reputable fueling station may charge in excess of the local rate for fuel.

Thus, there is a need to provide a system that provides an indication of the reputation or integrity of a fueling station based on the price paid and the volume of fuel received.

### SUMMARY

An objective of the invention is to fulfill the need referred to above. In accordance with the principles of an embodiment, this objective is obtained by a method of providing a rating of a fueling station to a user. The method determines whether a vehicle is located at a fueling station. When the vehicle is located at a particular fueling station a rating of the particular fueling station is communicated to a user of the vehicle.

In accordance with another aspect of an embodiment, a method of establishing a rating of a vehicle fueling station for dispensing fuel determines whether a vehicle is located at a fueling station and if so, identifies the fueling station. Based on at least one input of a user regarding the dispensed fuel, the method verifies whether an amount of fuel received by the vehicle is accurate compared to the total price of the fuel. A rating of the fueling station is provided based on the accuracy.

In accordance with yet another aspect of an embodiment, a method establishing a rating of a vehicle fueling station for dispensing fuel determines whether a vehicle is located at a fueling station and if so, identifies the fueling station. Based on at least one input of a user regarding the dispensed fuel, the method verifies whether a volume of fuel received by the vehicle during refueling is accurate based on a comparison with an actual, calculated volume of fuel received by the vehicle. A rating of the fueling station is provided based on the comparison.

In accordance with yet another aspect of an embodiment, a system for providing a reputation of a fueling station includes a control unit constructed and arranged to be carried by a vehicle. A positioning system obtains a position of the vehicle. A location database contains locations of fueling stations. A vehicle location circuit is constructed and arranged to compare a current vehicle location obtained from the positioning system with a fueling station location obtained from the location database to determine if the vehicle is at a fueling station and, if so, to identify the fueling station. A ratings database is in communication with the control unit and contains rating information of fueling stations, such that the control unit can obtain a rating of the fueling station at which the vehicle is located. A media source, associated with the vehicle, communicates the rating to a user of the vehicle.

Other objectives, features and characteristics of the present invention, as well as the methods of operation and the functions of the related elements of the structure, the combination of parts and economics of manufacture will become more apparent upon consideration of the following detailed description and appended claims with reference to the accompanying drawings, all of which form a part of this specification.

### BRIEF DESCRIPTION OF THE DRAWINGS

The invention will be better understood from the following detailed description of the preferred embodiments thereof, taken in conjunction with the accompanying drawings, wherein like reference numerals refer to like parts, in which:

FIG. 1 is schematic view of a fueling station reputation system provided in accordance with an embodiment.

FIG. 2 is a flow chart showing method steps of an embodiment.

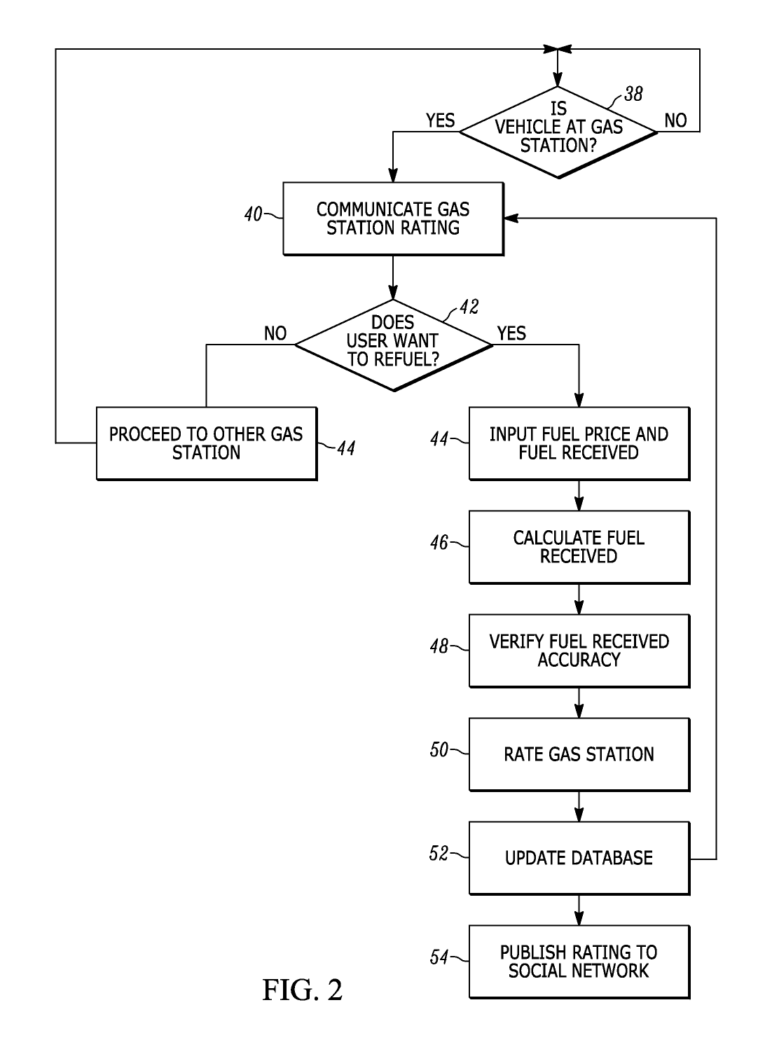

### DETAILED DESCRIPTION OF EXEMPLARY EMBODIMENTS

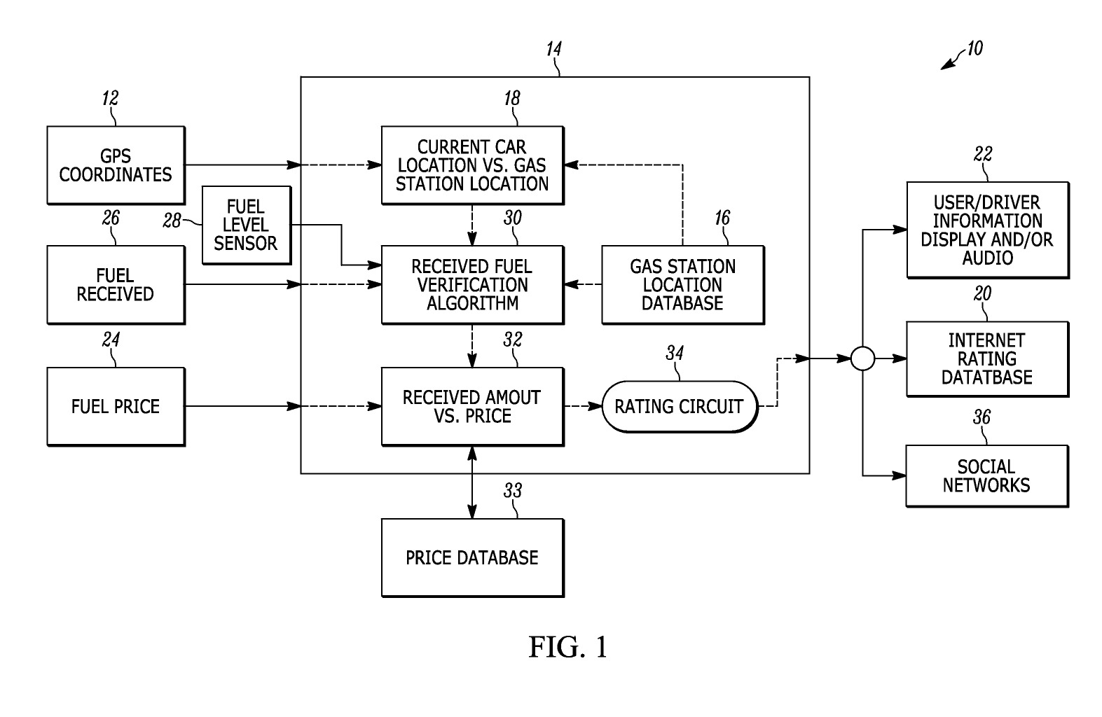

With reference to FIG. 1, a fueling station reputation system for a vehicle is shown, generally indicated at 10, in accordance with an embodiment. The system 10 includes a positioning system 12 such as a global positioning system (GPS) that provides GPS coordinates of the vehicle to a control unit 14 carried by the vehicle (not shown). Alternatively, the positioning system 12 can use Global Navigation Satellite System (GLONASS) or any other technology to locate the vehicle. The control unit 14 preferably includes a fueling station database 16. However, the database 16 can be remote from the control unit, with the control unit accessing the database 16. A vehicle location circuit 18 compares the current vehicle location from the GPS coordinates with a fueling station location (from database 16) to determine if the vehicle is at a fueling station and if so identifies the fueling station.

The fueling station identification is preferably based only on GPS location, not the fueling station name, address or station number.

If the vehicle is located at a fueling station, the control unit 14 polls an Internet ratings database 20 to obtain the reputation or rating information of this particular fueling station and communicates this information to the user by a media source such as a display 22 located in the vehicle or audibly through a speaker of the vehicle, or by both methods. For example, the display 22 can show one of three color codes regarding the reputation or rating of the fueling station. Green can be displayed when the fueling station has a good reputation considering the relationship between fueling price and amount of fueling received (as explained more fully below) based on input from other users. Yellow can be displayed if the fueling station in not very reliable based on the above criteria, or Red can be displayed when the fueling station has a very bad reputation based on the criteria above, permitting the driver to decide whether to proceed to another fueling station or fill at this fueling station (if absolutely necessary to receive fuel now).

If the user decides to refuel at the fueling station where the vehicle is presently located, the user may provide at least one input into the system 10 regarding the dispensed fuel. For example, the user may input the total amount of money paid (Fuel Price 24) for the fueling and/or the volume of Fuel Received 26 (and/or the grade or type of fuel) to the control unit 14. This data is obtained from the fueling pump or dispenser and is inputted by the user via a touch screen on the vehicle infotainment system, by voice commands or any other input methods. A verification processor circuit 30 verifies the Fuel Received 26. Thus, a previous level of fuel in the tank is subtracted from the new level of fuel in the tank, as obtained by fuel level sensor 28 provided in the fuel tank of the vehicle, to determine an actual, calculated volume of fuel received. This actual, calculated volume of fuel received is compared to the volume of Fuel Received 26 in circuit 30. For example, the dispenser displays Fuel Received as 10 gallons, but the actual, measured fuel received is 9.7 gallons, then the fueling station is considered to not be reputable and a rating can be based thereto as discussed below.

Alternatively, if only Fuel Price 24 is input by the user, processor circuit 32 verifies if the Fuel Received 26 is accurate based on the Fuel Price 24. The current local price per unit of the particular grade or type of fuel can be obtained from an Internet price database 33 or other reliable source. The system 10 can calculate the amount of fuel the vehicle received using data obtained from the level sensor 28. A rating can then be generated by the system 10 for the fueling system based on the Fuel Received 26 to Fuel Price 24 accuracy.

Thus, based on the above analyses, the system 10 automatically provides a rating of the fueling station via rating processor circuit 34 such as one of the three ratings noted above. The rating is sent to database 20 so that other users can have access to the rating. Optionally, the rating can also be sent to an Internet social network 36. As used herein the term “fuel” can include gasoline, ethanol blended gasoline, diesel fuel, LPG, electrical charge, or any other energy source typically used by vehicles.

With reference to FIG. 3, an embodiment of the steps or algorithm is shown for rating a fueling station using the system described above. In step 38, the GPS 12 determines if a vehicle located is at fueling station. If so, in step 40, the rating of the fueling station is communicated to the user audibly or by the display 22. In step 42, based on the rating, the user can decide whether to refuel at this fueling station or can proceed to another fueling station in step 44. If the user wants to contribute to the rating system, after refueling, in step 44, the user inputs the total Fuel Price 24 and Fuel Received 26 into the system 10. The system 10, in step 46, calculates the volume of actual fuel received from measurements obtained by the level sensor 28 as noted above. The accuracy of the Fuel Received 26 is verified in step 48 by comparing the volume of Fuel Received 26 to the actual, calculated volume of fuel received. Based on this accuracy, in step 50, the system 10 automatically rates the fueling station, using, for example, statistical analysis. In step 52, the database 20 is updated with the rating and in step 54, the rating can be published to a social network.

If electrical charge is the “fuel” for the vehicle, the system 10 can compare the electrical energy dispensed to the actual electrical energy received to the rate the fueling station.

Thus, by updating an external database 20, fueling station ratings or reputations can be accessible to other users in vehicles having the system 10. In addition, the ratings can be published on social networks. The system 10 is simple and eliminates the need for a user to take out a cell phone and start a mobile application. Furthermore, conventional cell phone applications do not verify if the price paid for fuel is for the actual amount of fuel received.

The operations and algorithms described herein can be implemented as executable code within the control unit 14 having processor circuits 30, 32 and 34 as described, or stored on a standalone computer or machine readable non-transitory tangible storage medium that are completed based on execution of the code by a processor circuit implemented using one or more integrated circuits. Example implementations of the disclosed circuits include hardware logic that is implemented in a logic array such as a programmable logic array (PLA), a field programmable gate array (FPGA), or by mask programming of integrated circuits such as an application-specific integrated circuit (ASIC). Any of these circuits also can be implemented using a software-based executable resource that is executed by a corresponding internal processor circuit such as a microprocessor circuit (not shown) and implemented using one or more integrated circuits, where execution of executable code stored in an internal memory circuit causes the integrated circuit(s) implementing the processor circuit to store application state variables in processor memory, creating an executable application resource (e.g., an application instance) that performs the operations of the circuit as described herein. Hence, use of the term “circuit” in this specification refers to both a hardware-based circuit implemented using one or more integrated circuits and that includes logic for performing the described operations, or a software-based circuit that includes a processor circuit (implemented using one or more integrated circuits), the processor circuit including a reserved portion of processor memory for storage of application state data and application variables that are modified by execution of the executable code by a processor circuit. The memory circuit can be implemented, for example, using a non-volatile memory such as a programmable read only memory (PROM) or an EPROM, and/or a volatile memory such as a DRAM, etc.

The foregoing preferred embodiments have been shown and described for the purposes of illustrating the structural and functional principles of the present invention, as well as illustrating the methods of employing the preferred embodiments and are subject to change without departing from such principles. Therefore, this invention includes all modifications encompassed within the spirit of the following claims.

What is claimed is:

1. A method of providing a rating of a fueling station to a user, the method comprising the steps of:
determining, using an apparatus, whether a vehicle is located at a fueling station, and
when the vehicle is located at a particular fueling station, communicating, via the vehicle, a rating of the particular fueling station to a user of the vehicle.

2. The method of claim 1, wherein the rating is based on a relationship between fuel price and amount of fuel received at the particular fueling station.

3. The method of claim 1, wherein the step of determining whether the vehicle is at a fueling station includes comparing the vehicle's GPS coordinates with a fueling station location database.

4. The method of claim 1, wherein the communicating step includes displaying the rating on a display of the vehicle.

5. The method of claim 4, wherein the step of displaying includes using a color coded display.

6. The method of claim 1, wherein the communicating step includes using audio to provide the rating to the user.

7. A method of establishing a rating of a vehicle fueling station for dispensing fuel, the method comprising the steps of:
determining, using an apparatus, whether a vehicle is located at a fueling station and if so, identifying the fueling station,
based on at least one input of a user regarding the dispensed fuel, verifying, in an apparatus, whether an amount of fuel received by the vehicle is accurate compared to the total price of the fuel, and
providing, with an apparatus, a rating of the fueling station based on the accuracy.

8. The method of claim 7, wherein the verifying step is based on the input of total fuel price.

9. The method of claim 7, further comprising, publishing, by an apparatus, the rating to a social network.

10. The method of claim 7, wherein the step of verifying includes obtaining the actual, calculated volume of fuel received by subtracting a new level of fuel in a tank of the vehicle from a previous level of fuel in the tank.

11. The method of claim 10, further comprising using a level sensor in the fuel tank to obtain the levels of fuel.

12. A method of establishing a rating of a vehicle fueling station for dispensing fuel, the method comprising the steps of:
determining, using an apparatus, whether a vehicle is located at a fueling station and if so, identifying the fueling station,
based on at least one input of a user regarding the dispensed fuel, verifying, in an apparatus, whether a volume of fuel received by the vehicle during refueling is accurate based on a comparison with an actual, calculated volume of fuel received by the vehicle, and
providing, with an apparatus, a rating of the fueling station based on the comparison.

13. The method of claim 12, wherein the verifying step is based on the input of fuel received by the vehicle.

14. The method of claim 12, further comprising, publishing, by an apparatus, the rating to a social network.

15. The method of claim 12, wherein the step of verifying includes obtaining the actual, calculated volume of fuel received by subtracting a new level of fuel in a tank of the vehicle from a previous level of fuel in the tank.

16. The method of claim 15, further comprising using a level sensor in the fuel tank to obtain the levels of fuel.

17. A system for providing a reputation of a fueling station, the system comprising:
a control unit constructed and arranged to be carried by a vehicle,
a positioning system for obtaining a position of the vehicle,
a location database containing locations of fueling stations,
a vehicle location circuit constructed and arranged to compare a current vehicle location obtained from the positioning system with a fueling station location obtained from the location database to determine if the vehicle is at a fueling station and, if so, to identify the fueling station,
a ratings database, in communication with the control unit, containing rating information fueling stations, such that the control unit can obtain a rating of the fueling station at which the vehicle is located, and
a media source, associated with the vehicle, for communicating the rating to a user of the vehicle.

18. The system of claim 17, wherein the positioning system is a global positioning system (GPS).

19. The system of claim 16, further comprising:
a verification processor circuit constructed and arranged to verify a volume of fuel received from a dispenser at the fueling station, and
another processor circuit constructed and arranged to verify whether the fuel received is accurate based on a total price of the fuel.

20. The system of claim 19, further comprising a level sensor in a fuel tank of the vehicle such that data obtained by the level sensor can be used by the verification processor circuit.
